(19) United States
(12) Patent Application Publication
(10) Pub. No.: US 2020/0249876 A1
(43) Pub. Date: Aug. 6, 2020

(54) SYSTEM AND METHOD FOR DATA STORAGE MANAGEMENT

(71) Applicant: RepliXio LTD., Tel-Aviv (IL)

(72) Inventors: Cyril PLISKO, Petah Tikva (IL); Sam GENZEL, Jerusalem (IL); Andrey VESNOVATY, Holon (IL); Michael GREENBERG-SMIRNOFF, Tel Aviv (IL); Avi SHILLO, Kfar Saba (IL)

(73) Assignee: RepliXio LTD., Tel-Aviv (IL)

(21) Appl. No.: 16/854,263

(22) Filed: Apr. 21, 2020

Related U.S. Application Data
(63) Continuation of application No. PCT/US2018/066215, filed on Dec. 18, 2018.
(60) Provisional application No. 62/599,854, filed on Dec. 18, 2017.

(51) Int. Cl. G06F 3/06

(52) U.S. Cl. CPC G06F 3/0659; G06F 3/0673; G06F 3/0604

(57) ABSTRACT

A system and method for data storage management. The method includes: generating a first container of a first write command; designating the first container with a current container status; when it is determined that a destination overlap exists between at least a second write command and the first write command: generating a second container of the at least a second write command; voiding the current container status of the first container and designating the second container with the current container status; and inserting the at least a second write command in the second container designated with the current container status

### CROSS-REFERENCE TO RELATED APPLICATIONS

This application is a continuation of International Patent Application No. PCT/US2018/066215 filed Dec. 18, 2018, now pending, which claims the benefit of U.S. Provisional Application No. 62/599,854 filed on Dec. 18, 2017, the contents of which are hereby incorporated by reference.

### TECHNICAL FIELD

The present disclosure relates generally to distributed computing environments, and more particularly to systems and methods for storage management of data in a distributed computing environment.

### BACKGROUND

The modern information technology (IT) environment is not homogenous, but rather consists of traditional data centers, private clouds, public clouds or, in many cases, a combination of all of the above. Due to the cloud-favorable economics in enterprises, more and more IT environments are currently shifting their IT workloads to cloud-based infrastructures.

Many enterprises and other large organizations will eventually choose to deploy their workloads in multiple cloud infrastructures simultaneously, for increased vendor independency, redundancy, and cost control. Recent data released shows that hybrid clouds, which include combinations of private, local, and public cloud networks, represents 57% of the total enterprise cloud deployments in 2016, up from 19% in 2015. In order to facilitate this change, it is important to be able to easily shift or balance resources from one cloud infrastructure to another.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for data storage management. The method includes: generating a first container of a first write command; designating the first container with a current container status; when it is determined that a destination overlap exists between at least a second write command and the first write command: generating a second container of the at least a second write command; voiding the current container status of the first container and designating the second container with the current container status; and inserting the at least a second write command in the second container designated with the current container status.

Certain embodiments disclosed herein also include a method for data storage management. The method includes: receiving a read command; generating a second container of at least a second write command when it is determined that a destination overlap exists between the read command and a first write command in a first container designated with a current container status; voiding the current container status of the first container and designating the second container with the current container status; updating a data structure with the voided current container status of the first container; determining a location of data associated with the read command based on the data structure.

Certain embodiments disclosed herein also include a system for data storage management. The system includes: a processing circuitry; and a memory, the memory containing instructions that, when executed by the processing circuitry, configure the system to: generate a first container of a first write command; designate the first container with a current container status; when it is determined that a destination overlap exists between at least a second write command and the first write command: generate a second container of the at least a second write command; void the current container status of the first container and designating the second container with the current container status; and insert the at least a second write command in the second container designated with the current container status.

Certain embodiments disclosed herein also include a system for data storage management. The system includes a processing circuitry; and a memory, the memory containing instructions that, when executed by the processing circuitry, configure the system to: receive a read command; generate a second container of at least a second write command when it is determined that a destination overlap exists between the read command and a first write command in a first container designated with a current container status; void the current container status of the first container and designating the second container with the current container status; update a data structure with the voided current container status of the first container; determine a location of data associated with the read command based on the data structure.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a block diagram of a system for data storage management according to an embodiment.

FIG. 1B is an example block diagram of the data management optimizer according to an embodiment.

FIG. 2 is a flowchart describing a method for performing data storage management according to an embodiment.

FIG. 3 is a flowchart describing a method for rapid retrieval of data for use with a system for data storage management according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Some example embodiments disclosed herein allow for rapid and stable insertion and retrieval of data into and from a multi-source data environment. The disclosed embodiments employ overlap identification techniques as further described herein in order to prevent the use of traditional lock techniques which can cause major latency issues when executing write and read commands. Moreover, the disclosed embodiments allow for an efficient implementation of within a distributed system.

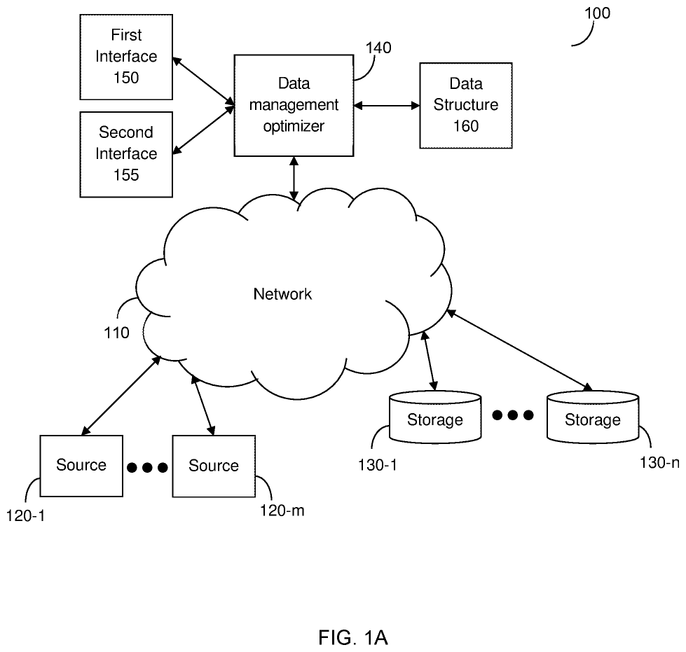

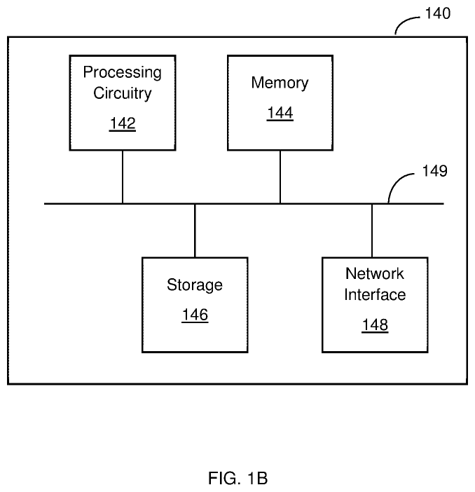

FIG. 1A is an example block diagram of a system 100 for data storage management according to an embodiment. A data management optimizer 140 is communicatively connected to a network 110. The network 110 may be a local area network (LAN), a wide area network (WAN), the worldwide web (WWW), the Internet, and any combinations thereof.

The data management optimizer 140 is connected to a first interface 150 configured to receive at least one write command from one or more sources 120-1 through 120-m, where m is an integer equal to or greater than 1 (hereinafter referred to individually as a source 120 and collectively as sources 120, merely for simplicity). The sources 120 are communicatively connected to the first interface 150 via the network 110. The sources 120 may include servers from which write or read commands are received as further described below. Each write or read command relates to data and metadata designated for storing, or stored, in one or more storages 130-1 through 130-n, where n is an integer equal to or greater than 1 (hereinafter referred to individually as a storage 130 and collectively as storages 130). In an embodiment, the storages 130 are located remotely and accessed through the network 110. In a further embodiment, the storages 130 and located locally with respect to the first interface 150.

The system 100 further includes a second interface 155 that is communicatively connected, through the network 110, to the at least one storage 130. The storage 130 may be for example, a database, a cloud database, and so on.

In an embodiment, the data management optimizer 140 is communicatively connected to the first interface 150 and the second interface 155 and further configured to generate a first container of write commands. The container includes transactions containing at least one write command for writing data to a storage 130. The data management optimizer 140 designates a current container status for the first container. The current container status indicates that the container is available for receiving write commands to be inserted into the first container. In an embodiment, the first container includes a first sequence identifier, e.g., a number, a letter, a combination thereof, and the like.

The data management optimizer 140 may be further configured to insert a second write command into the container designated with the current container status upon determination that no destination overlap exists between the second write command and at least one write command that was previously stored in the first container designated with the current container status. The destination is a memory portion within a storage 130 at which the data, associated with each write command, is set to be stored.

This destination overlap determination may be achieved by comparing the destination of data in the second write command and the destination of data of the first write command. Additionally, metadata associated with the write commands may be indicative of the destination of the data of each write command. For example, metadata associated with the second write command may indicate that the destination of the data of the second write command is between the first portion memory and the third portion memory of a storage 130. According to the same example, the metadata of the first write command may indicate that the destination of data associated with the first write command is in the fourth portion memory and, therefore, there is no overlap between the second write command and the first write command.

If there is a determination that a destination overlap exists between a second write command and at least one write command in a container designated the current container status, e.g., the first write command, the data management optimizer 140 generates a second container of write commands. The determination that a destination overlap exists may be achieved using the metadata of the write commands for identifying the destination of the data associated with each write command as further described herein above.

Similar to the first container, the second container is a batch file that includes at least one write command. In an embodiment, the second container has a second sequence identifier that immediately trails the first sequence identifier. For example, in case the first sequence identifier is ‘4’ the second sequence identifier is ‘5’, and in case the first sequence identifier is ‘7’ the second sequence identifier is ‘8’, and so on. This allows for more efficient identification of the various containers with relation to each other.

When an overlap is determined to exist, the data management optimizer 140 voids the current container status of the first container and designates the second container the current container status. Then, the data management optimizer 140 inserts the second write command into the second container, which is now designated as the current container status. Thus, when a destination overlap does exist, the data management optimizer 140 causes the first container previously designated as the current container to stop receiving write commands and the second container, now having the current status, to begin to receive the write commands in its stead.

According to an embodiment, each container may store therein write commands having one of three possible types of commands statuses: (1) a complete status, (2) an incomplete status, and (3) a foreign status. A complete status means that all the data associated with the write commands has already been transferred to a designated storage 130. An incomplete status means portions of the data or all of the data associated with the write commands has not yet been transferred. A foreign status means that it cannot be determined whether the data was transferred yet to the designated storage 130. When all write commands in a container are associated with the complete status or foreign status, the container is sent to a log file as further described herein below. It should be noted that only containers that are not designated with a current container status are sent to the log file.

The log file is an object in a memory that includes sequence identifiers. Because the log file records the events and contains the sequence identifier of each container, it may also be used to arrange a plurality of containers in their actual order and not by the order they were received at the log file. That is to say, in case a container having a sequence identifier of ‘7’ is received at the log file before a container having a sequence identifier of ‘6’, the log file us used to rearrange the order of the containers. The rearrangement is based on the containers' sequence identifiers such that the containers are stored in their actual order, i.e., the order at which they were initially generated, not necessarily the order at which they were recorded within the log file.

According to one embodiment, the data management optimizer 140 is further configured to restore, using the log file, the storage 130 to a boundary between a plurality of containers that does not include the current container status. The restoration may be achieved by searching for the sequence identifier of a desirable container. In an example scenario in which a node is missing for a period of time and this is recovered, it can be synced and placed in the correct location in the storage 130 easily, as the containers are numbered in ascending order, allowing the data management optimizer 140 to place the node in the correct place within the storage 130.

The system 100 further includes a data structure, shown as data structure 160 in FIG. 1B. The data structure 160 is a search tree that allows rapid identification of the data location. The data structure 160 includes a plurality of prefixes, each prefix is associated with at least one container having the complete status or the foreign status, i.e., it does not include the current container status. The data management optimizer 140 updates the data structure 160 with any container that does not have the current container status. The update may be achieved by sending each container that does not include the current container status to the data structure 160.

The data structure 160 enables identification of the location of data associated with each write or read command stored in a container using the prefixes associated with each container. By using the prefixes, read commands received at the first interface 150 are performed more quickly, as the retrieval process begins with searching within the data structure 160 for the location of the data instead of searching within the storage. Thus, the location of the data is identified. In an embodiment, the data may be stored within the storage 130, such as a cloud database, or within a persistent shared memory to which the processing circuitry may be connected.

FIG. 1B is an example block diagram of the data management optimizer 140 according to an embodiment. The data management optimizer 140 includes a processing circuitry 142 coupled to a memory 144, an internal storage 146, and a network interface 148. In an embodiment, the components of the data management optimizer 140 may be communicatively connected via a bus 149.

The processing circuitry 142 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

In another embodiment, the memory 144 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 142 to perform the various processes described herein.

The data management optimizer 140 is communicatively connected to a first interface 150, a second interface, and a data structure 160, as described aboved in FIG. 1A. The data structure 160 may be a trie data structure.

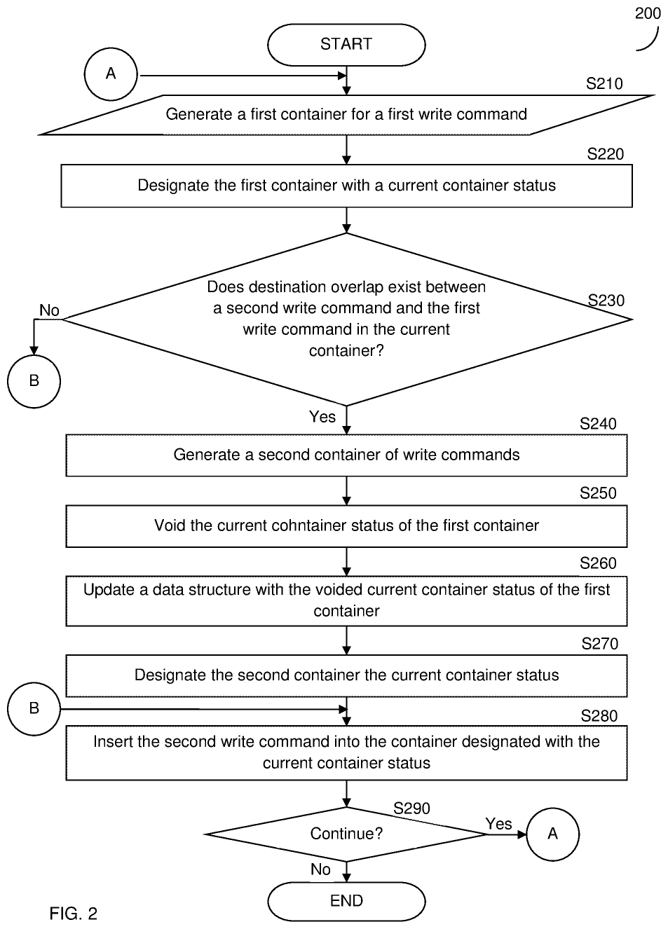

FIG. 2 is an example flowchart 200 of a method for performing data storage management according to an embodiment.

At S210, a first container of at least a first write command is generated as further described herein above with respect of FIG. 1. At S220, a current container status is designated to the first container. The first container status indicates that the first container functions as the sole container to which write commands are sent.

At S230, it is determined whether a destination overlap exists between at least a second write command and the first write command. If an overlap exists, execution continues with S240; otherwise, execution continues with S270. The overlap determination may be achieved based on a comparison of the destination of the data of the second write command and the destination of the data of the first write command. In an embodiment, metadata associated with the write commands may be indicative of the destination of the data of each write command.

At S240, a second container of write commands is generated, and at S250, the current container status of the first container is voided. At S260, a data structure is updated with the voided current container status of the first container. The data structure is further described at FIG. 1.

The data structure is updated, e.g., by a processing circuitry, with each container that had been previously designated with a current container status but no longer has that status. Thus, a container currently designated as having a current container status will not appear in the data structure as long as the current container status is valid.

At S270, the second container is designated with the current container status. At S280, the second write command is inserted into that current container.

At S290, it is checked whether to continue the operation and if so execution continues with S210; otherwise, execution terminates.

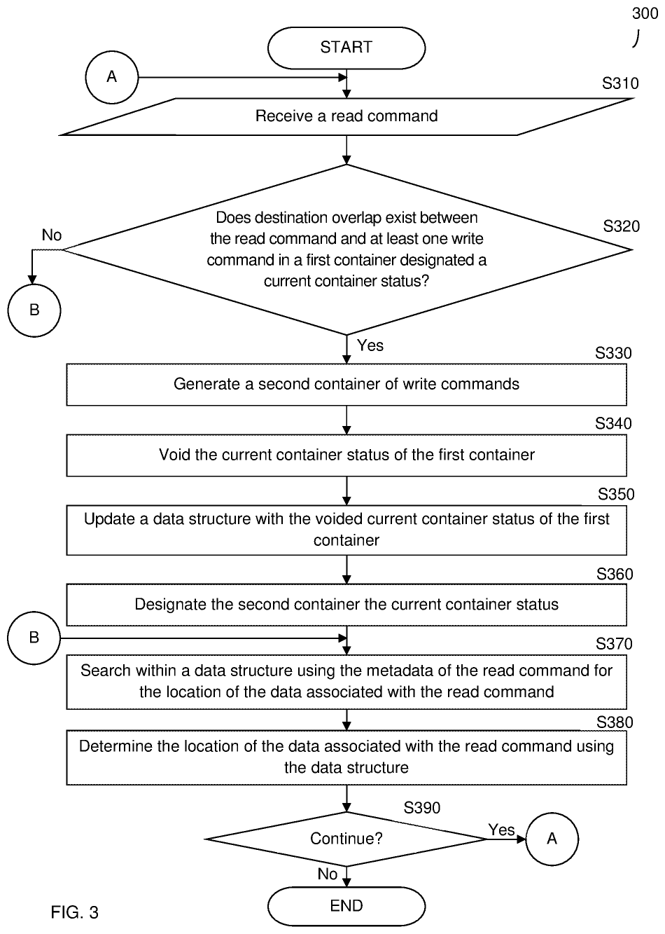

FIG. 3 is an example flowchart 300 of a method for rapid retrieval of data for use with a system for data storage management according to an embodiment.

At S310, a read command is received, e.g., by a first interface. The read command is a request to retrieve data from a storage, e.g. a cloud database, a persistent shared memory, a server, and the like. The read command is a request to retrieve data from a certain location, such as a specific memory portion. The read command includes metadata that indicates a the destination from which the data will be retrieved, such as a destination in a memory portion where the desired data had been previously stored.

At S320, it is determined, e.g., by a data management optimizer, whether a destination overlap exists between the received read command and at least one write command in a first container designated with a current container status. The first container is a batch file includes at least one write command, and the current container status indicates that the first container is available for receiving write commands, where the write commands may be inserted into the first container having the current container status. The first container includes a first sequence identifier, which may include, for example, a number, a letter, a combination thereof, and the like.

The determination may be achieved by comparing the destination of the data of the read command and the destination of the data of the at least one write command within the first container. As noted above, the metadata associated with the read and write commands may be indicative of the destination of the data of each of the read and write commands. For example, the metadata associated with the received read command may indicate that the destination of the data of the read command is located between a first portion of a memory and a third portion of a memory.

According to the same example, the metadata of a write command that was previously inserted into the first container may indicate that the destination of the data associated with the write command is within a forth portion of a memory. In such a scenario, there is no overlap between the read command and the write command.

In cases where an overlap does not exist, execution continues at S370; otherwise, execution continues with S330. At S330, a second container of write commands is generated, e.g., by the data management optimizer. At S340, the current container status of the first container is voided. At S350, a data structure 160 is updated with the voided current container status of the first container. The data structure is further described at FIG. 1. In an embodiment, the data structure is updated with every container that previously was designated with a current container status but does not have the current container status anymore. That is to say, a container having the current container status shall not appear in the data structure 160 as long as the current container status is valid. At S360, the second container is designated with the current container status.

At S370, the data structure is searched, using the metadata of the read command, for the location of the data associated with the read command. The data may be stored in a storage, in a persistent shared memory, in a server, and the like.

At S380, based on the search, the location of the data associated with the read command is determined based on the data structure. At S390, it is checked whether to continue the operation and if so execution continues with S310; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing circuitries (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for data storage management, comprising:
generating a first container of a first write command;
designating the first container with a current container status;
when it is determined that a destination overlap exists between at least a second write command and the first write command:
generating a second container of the at least a second write command;
voiding the current container status of the first container and designating the second container with the current container status; and
inserting the at least a second write command in the second container designated with the current container status.

2. The method of claim 1, further comprising:
recording within a log file any container that has had its current container status designation voided.

3. The method of claim 2, wherein the log file is an object that includes sequence identifiers, and wherein a container includes at least one transaction containing at least one write command.

4. The method of claim 1, further comprising:
sending any container having a current container status designation voided to a data structure, wherein the data structure includes a plurality of prefixes, wherein each of the plurality of prefixes is associated with a container.

5. The method of claim 4, further comprising:
determining a location of data related to the first write command and the at least a second write command based on the data structure.

6. A non-transitory computer readable medium having stored thereon instructions for causing a processing circuitry to perform the method of claim 1.

7. A method for data storage management, comprising:
receiving a read command;
generating a second container of at least a second write command when it is determined that a destination overlap exists between the read command and a first write command in a first container designated with a current container status;
voiding the current container status of the first container and designating the second container with the current container status;
updating a data structure with the voided current container status of the first container;
determining a location of data associated with the read command based on the data structure.

8. The method of claim 7, wherein the read command includes metadata indicative of a destination from where data requested by the read command is retrieved.

9. The method of claim 7, further comprising:
recording within a log file any container that has had its current container status designation voided.

10. The method of claim 7, wherein the log file is an object that includes sequence identifiers, and wherein a container includes at least one transaction containing at least one write command.

11. A non-transitory computer readable medium having stored thereon instructions for causing a processing circuitry to perform the method of claim 7.

12. A system for data storage management, comprising:
a processing circuitry; and
a memory, the memory containing instructions that, when executed by the processing circuitry, configure the system to:
generate a first container of a first write command;
designate the first container with a current container status;
when it is determined that a destination overlap exists between at least a second write command and the first write command:
generate a second container of the at least a second write command;
void the current container status of the first container and designating the second container with the current container status; and
insert the at least a second write command in the second container designated with the current container status.

13. The system of claim 12, wherein the system is further configured to:
record within a log file any container that has had its current container status designation voided.

14. The system of claim 13, wherein the log file is an object that includes sequence identifiers, and wherein a container includes at least one transaction containing at least one write command.

15. The system of claim 12, wherein the system is further configured to:
send any container having a current container status designation voided to a data structure, wherein the data structure includes a plurality of prefixes, wherein each of the plurality of prefixes is associated with a container.

16. The system of claim 15, wherein the system is further configured to:
determine a location of data related to the first write command and the at least a second write command based on the data structure.

17. A system for data storage management, comprising:
a processing circuitry; and
a memory, the memory containing instructions that, when executed by the processing circuitry, configure the system to:
receive a read command;
generate a second container of at least a second write command when it is determined that a destination overlap exists between the read command and a first write command in a first container designated with a current container status;
void the current container status of the first container and designating the second container with the current container status;
update a data structure with the voided current container status of the first container;
determine a location of data associated with the read command based on the data structure.

18. The system of claim 17, wherein the read command includes metadata indicative of a destination from where data requested by the read command is retrieved.

19. The system of claim 17, wherein the system is further configured to:
record within a log file any container that has had its current container status designation voided.

20. The system of claim 17, wherein the log file is an object that includes sequence identifiers, and wherein a container includes at least one transaction containing at least one write command.
